(19) United States
(12) Patent Application Publication
(10) Pub. No.: US 2025/0209480 A1
(43) Pub. Date: Jun. 26, 2025

(54) MONITORING METHOD FOR BILL AND LEGAL REGULATION AND PROGRAM THEREFOR

(71) Applicant: CODIT CORP., Seoul (KR)

(72) Inventors: Ji Eun CHUNG, Seongnam-si (KR); Heejoon LEE, Seoul (KR); Lira KIM, Seoul (KR)

(21) Appl. No.: 18/851,275

(22) PCT Filed: Mar. 30, 2022
(86) PCT No.: PCT/KR2022/004482

§ 371 Date: Sep. 26, 2024

(51) Int. Cl. G06Q 30/0202; G06Q 10/0635; G06Q 50/18; G06Q 50/26

(52) U.S. Cl. CPC G06Q 30/0202; G06Q 10/0635; G06Q 50/18; G06Q 50/26

(57) ABSTRACT

A monitoring method for a bill and regal regulation according to an embodiment of the present invention, which is performed by a computing system comprising at least one memory and at least one processor, comprises the steps of: storing template information including a preset item; receiving, from a user terminal, basic information including main contents and proposal reasons of a bill; storing the received basic information in an analysis server; forming, on the basis of the preset item, extracted information from the basic information via text mining; generating regulation influence analysis data on the basis of the extracted information and the template information; and on the basis of the generated regulation influence analysis data, outputting a regulation influence analysis interface for the bill or legal regulation to the user terminal.

### CROSS-REFERENCE TO PRIOR APPLICATIONS

This application is a National Stage Patent Application of PCT International Patent Application No. PCT/KR2022/004482 (filed on 30 Mar. 2022), which is hereby incorporated by reference in its entirety.

### TECHNICAL FIELD

The present invention relates to a method for monitoring a bill and a legal regulation and a program therefor, and more specifically, to a technology for providing influence analysis data according to regulations.

### BACKGROUND ART

The bills to be amended or proposed include a government legislation bill and a member bill.

When regulations are strengthened by the government legislation bill, the government manually prepares a regulation influence analysis report to analyze the influence of the relevant regulations.

However, when the regulations are weakened by government legislation bill, a separate regulation influence analysis report is not prepared.

Meanwhile, in a case of the member bill, the regulation influence analysis report is not prepared regardless of strengthening or weakening of the regulations.

The regulation influence analysis report is a document provided to the public by manually writing contents of the analysis by the government on a regulation affairs name, a regulation provision, a delegated law, a type, pre-announcement of legislation, background of promotion, necessity of government intervention, a regulation objective, a regulation content, a regulated group and stakeholder, a cost benefit analysis, influence evaluation, sunset setting, priority permission and post-regulation application, and a cost management system when the government legislation is proposed.

As described above, the regulation influence analysis report is currently prepared only when the regulations are strengthened or newly established among government legislation bills, and the regulation influence analysis report is not prepared for the member bills, so that it is difficult to determine what influence the regulations will have on related industries and related companies.

In addition, it cannot be said that reliability of data is high because the current regulation influence analysis report is manually prepared by a person, and in particular, if an author fails to find data about relevant overseas cases and similar legislative cases, the data is marked as not applicable in the regulation influence analysis report, so that incorrect information may be provided to the public.

### DISCLOSURE

### Technical Problem

An object to be solved by the present invention is to provide a method for monitoring a bill or legal regulation by providing regulation influence analysis data about a bill that is proposed by a computing system, and a program therefor.

The object to be solved by the present invention is to provide are not limited to the aforementioned technical objects, and other technical objects not described above may be evidently understood by a person having ordinary skill in the art to which the present invention pertains from the following description.

### Technical Solution

According to one embodiment of the present invention, a method for monitoring a bill or legal regulation, which is performed by a computing system including at least one memory and at least one processor, includes: storing template information including a preset item; receiving, from a user terminal, basic information including main contents and proposal reasons of the bill; storing the basic information in an analysis server; forming extracted information from the basic information through text mining, based on the preset item; generating regulation influence analysis data based on the extracted information and the template information; and outputting a regulation influence analysis interface for the bill or legal regulation to the user terminal, based on the generated regulation influence analysis data.

In this case, the forming of the regulation influence analysis data may include generating regulation influence analysis data by matching the extracted information to each preset item in the template information.

In addition, the preset item may include a regulation affairs name, a regulation provision, a delegated law, a type, pre-announcement of legislation, a background of promotion, necessity of government intervention, a regulation objective, a regulation content, a regulated group, a stakeholder, cost benefit analysis, influence evaluation, sunset setting, priority permission, post-regulation application, a cost management system, a regulated industry, a close-up industry, and a related company.

In addition, the generating of the regulation influence analysis data may further include: calculating a first relevance between the proposed bill and the extracted information corresponding to each of the regulated group and the stakeholder, the regulated industry, the close-up industry, and the related company, based on a predetermined similarity calculation equation; and generating regulation influence analysis data about the first relevance.

According to on embodiment of the present invention, the method for monitoring a bill or legal regulation may further include receiving, when logging-in to the computing system using an account of a specific company, information about the specific company provided from a company information providing server through an application programming interface (API) provided from the company information providing server, in which the generating of the regulation influence analysis data may further include: calculating a second relevance between the specific company and the bill based on a predetermined similarity calculation equation; generating regulation influence analysis data about the second relevance; converting the regulation influence analysis data about the second relevance into a percentage; and outputting the percentage to the user terminal based on the information about the specific company, and the second relevance may be included in the preset item.

According to on embodiment of the present invention, the method for monitoring a bill or legal regulation may further include receiving, when logging-in to the computing system using an account of a specific company, information about the specific company provided from a company information providing server through an application programming interface (API) provided from the company information providing server, in which the generating of the regulation influence analysis data may further include: calculating a risk of the specific company by the bill based on a predetermined first algorithm; generating regulation influence analysis data about the risk; converting the regulation influence analysis data about the risk into visual data based on the risk corresponding to the regulation influence analysis data; and outputting the visual data to the user terminal based on the information about the specific company, the risk may be included in the preset item, and the visual data may include saturation information corresponding to the risk.

According to on embodiment of the present invention, the method for monitoring a bill or legal regulation may further include: performing supervised learning through a learning model based on training data that is stored in association with basic information of a first proposed bill, basic information of a first past bill, first past regulation influence analysis data, and first inference data; forming learning data through machine learning of the learning model; providing an artificial intelligence module with the learning data; outputting second inference data based on the learning data received from the learning model, when basic information of a second proposed bill, basic information of a second past bill, and second past regulation influence analysis data are input; forming feedback information based on a difference between the second inference data and a pre-stored ground truth set; and changing a parameter of the learning model based on the feedback information.

In this case, the generating of the regulation influence analysis data may include generating the regulation influence analysis data based on mining data, which is obtained by performing text mining on the basic information, and the second inference data.

According to one embodiment of the present invention, the method for monitoring a bill or legal regulation may further include: determining a relevant overseas case and a similar legislative case corresponding to the basic information using a predetermined second algorithm; extracting main contents of the relevant overseas case and the similar legislative case; transmitting the main contents to the user terminal; and outputting the main contents to the user terminal.

According to one embodiment of the present invention, in the method for monitoring a bill or legal regulation, when the basic information of the second proposed bill includes basic information about a member bill, it may be determined that the preset item further includes a political party and legislative tendency of a member who proposes a second bill.

According to one embodiment of the present invention, the method for monitoring a bill or legal regulation may be executed by computer program stored in a medium.

### Advantageous Effects

According to the method for monitoring a bill and a legal regulation and the program therefor according to one aspect of the present invention, even when the regulation by the government legislation bill is weakened, the regulation may act as a new opportunity for a related industry or a related company, so that it is possible to provide useful information when a company is operated through regulation influence analysis data.

According to the method for monitoring a bill and a legal regulation and the program therefor according to one aspect of the present invention, by analyzing the relevant regulation contents prior to proposing or amending the member bill, it is possible to provide useful information for business operation through the regulation influence analysis data when the bill is proposed.

According to the method for monitoring a bill and a legal regulation and the program therefor according to one aspect of the present invention, it is possible to recommend an industry and a company that may be affected by the relevant regulation.

According to the method for monitoring a bill and a legal regulation and the program therefor according to one aspect of the present invention, it is possible to provide information about a relationship between a specific company and the relevant regulation and a risk in accordance with the regulation of the specific company.

According to the method for monitoring a bill and a legal regulation and the program therefor according to one aspect of the present invention, it is possible to automatically search for information about relevant overseas cases and similar legislative cases and provide the information to the user.

The effects of the present invention are not limited to the effects described above, and other effects that are not described will be clearly understood by those skilled in the art from the following description.

### DESCRIPTION OF DRAWINGS

FIG. 1 is a view for schematically showing components that provide a method for monitoring a bill and a legal regulation according to one embodiment.

FIG. 2 is a view for explaining an operation of generating regulation influence analysis data obtained by matching extracted information corresponds to a preset template information according to one embodiment.

FIG. 3 is a view for showing an interface of a user terminal to which the template information is output according to one embodiment.

FIG. 4 is a view for showing a screen in which regulation influence analysis data, which corresponds to a regulated group and stakeholder, a regulated industry, a close-up industry, and a related company, is generated and output to the user terminal.

FIG. 5 is a view for showing an operation of outputting visual data about a relevance and a risk by receiving a company information API from a company information providing server when login is made with a company account, according to one embodiment.

FIG. 6 is a view schematically showing a process of generating regulation influence analysis data through artificial intelligence (AI) learning according to one embodiment.

FIG. 7 is a view for explaining an operation of generating regulation influence analysis data through text mining and machine learning according to one embodiment.

FIG. 8 is a view for explaining an operation of generating inference data through machine learning according to one embodiment.

FIG. 9 is a view for explaining an output value according to the presence or absence of a relevant overseas case and a similar legislative case according to one embodiment.

FIG. 10 is a view for explaining an operation of adding the template information when basic information about a member bill is received, according to one embodiment.

### BEST MODE

The advantages and characteristics of the present invention and a method of achieving the advantages and characteristics will become more apparent from the embodiments described in detail in conjunction with the accompanying drawings. However, the present invention is not limited to the embodiments to be described later, but may be implemented in various different ways. The embodiments are provided to only complete the disclosure of the present invention and to allow those skilled in the art to fully understand the category of the disclosure. The present invention is defined by the category of the claims.

The term used herein is for the purpose of describing embodiments and is not intended to limit the inventive concept. In the specification, the singular forms include plural forms unless particularly mentioned. The terms “comprises” and/or “comprising” used herein does not exclude presence or addition of one or more other elements, in addition to the above-mentioned elements. The same reference numerals refer to the same elements throughout the specification, and “and/or” include each and every combination of one or more of the aforementioned elements. Terms used in the specification, “first”, “second”, etc., are used to describe various components, but the components are not to be interpreted to be limited to the terms. These terms are used only to distinguish one component from another. Therefore, the first component mentioned below may be the second component within the technical scope of the present invention.

Unless defined otherwise, all terms (including technical and scientific terms) used herein may be used in a sense that is commonly understood by one of ordinary skill in the art to which the present invention belongs. In addition, commonly used predefined terms are not ideally or excessively interpreted unless explicitly defined otherwise.

Meanwhile, the “bill” or “legal regulation” described herein may mean various types of laws that are commonly understood. Specifically, the “bill” or “legal regulation” herein may mean a constitution, a law, an enforcement decree, a decree, an enforcement rule, an ordinance, a rule, a rule, a rule, etc. In addition, the “government legislation bill”, the “member bill”, or the “bill” described herein may mean an agenda proposed for the above-described “bill” or “legal regulation”.

Hereinafter, the embodiments of the present invention will be described in detail with reference to accompanying drawings.

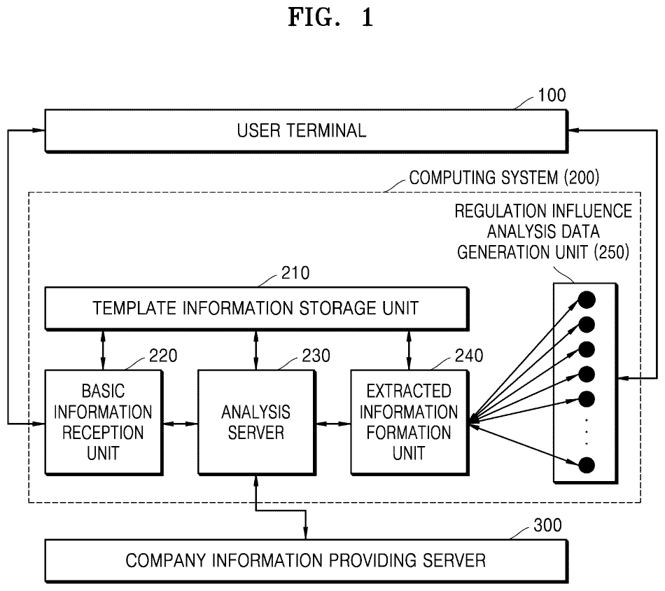

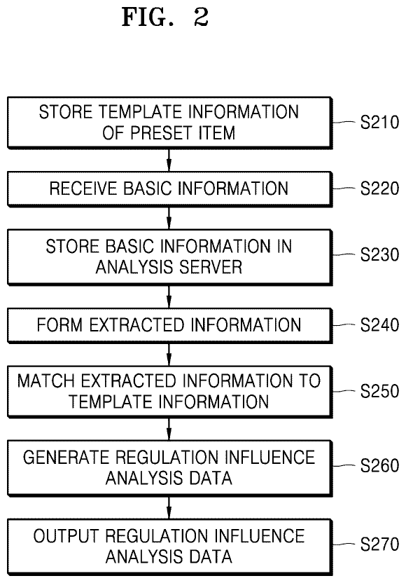

FIG. 1 is a view for schematically showing components that provide a method for monitoring a bill and a legal regulation according to one embodiment of the present invention, and FIG. 2 is a view for explaining an operation of generating regulation influence analysis data obtained by matching extracted information a preset template information according to one embodiment of the present invention.

As shown in FIGS. 1 and 2, in the method for monitoring a bill and a legal regulation, which is performed by a computing system 200 including at least one memory and at least one processor, a template information storage unit 210, a basic information reception unit 220, an analysis server 230, an extracted information formation unit 240, a regulation influence analysis data generation unit 250, and a user terminal 100 may be provided in order to perform an operation of the present invention.

The user terminal 100 may include all types of handheld-based wireless communication devices that may be connected to a web server through a network, such as a mobile phone, a smartphone, a personal digital assistant (PDA), a portable multimedia player (PMP), and a tablet PC, and may be one of digital devices including a memory unit such as a personal computer (e.g., a desktop computer, a notebook computer, and the like), a workstation, a PDA, and a web pad and having computational ability while being equipped with a microprocessor.

On the other hand, the user terminal 100 may include a display to which an interface is output, a communication module, at least one processor provided so as to run an application on the user terminal, and the like.

Meanwhile, the computing system 200 generally means a computer-related entity, and may mean, for example, hardware, a combination of hardware and software, or software.

The template information storage unit 210 in the computing system 200 may store template information including a preset item (S210).

The template information may be updated for one or more items by an authorized administrator in the computing system 200.

The template information may include a regulation affairs name, a regulation provision, a delegated law, a type, pre-announcement of legislation, a background of promotion, necessity of government intervention, a regulation objective, a regulation content, a regulated group and stakeholder, cost benefit analysis, influence evaluation, sunset setting, priority permission and post-regulation application, and a cost management system, a regulated industry, a close-up industry, a related company, a relevance, a risk, a relevant overseas case/similar legislative case, and a political party, legislative tendency, and related information of a member.

The basic information reception unit 220 in the computing system 200 may receive basic information including proposal reasons and main contents of the bill from the user terminal 100 (S220).

The main contents may mean the amended contents of the proposed bill.

The proposed bill may mean a government legislation bill and/or a member bill.

The received basic information is basic information provided at the time of amending or proposing the government legislation bill or the member bill (hereinafter collectively referred to as “bill”), and may include a competent ministry, a person in charge, contact information of the person in charge, a date of the pre-announcement of the legislation, a bill name, a proposer (proposal date), a standing committee (competent ministry), a current state of the National Assembly (promotion date), a current state of the resolution (resolution date), a bill number (alternative number), proposal reasons/main contents of the bill, and contents of the current law and the revised law.

Meanwhile, the received basic information may be stored in the analysis server 230 of the computing system 200.

The analysis server 230 may receive an API provided from a company information providing server 300.

The company information providing server 300 may refer to a server that provides company information.

The API provided from the company information providing server 300 may be an API provided from a data analysis retrieval and transfer system (DART).

The API provided from the company information providing server 300 may be an API provided from Korea Relating & Data (KoDART).

Meanwhile, the basic information stored in the analysis server 230 may be transmitted to the extracted information formation unit 240.

The extracted information formation unit 240 may generate mining data by performing text mining on the transmitted basic information, and if necessary, may generate inference data by performing machine learning.

The extracted information formation unit 240 may form extracted information through data generated by the text mining or the machine learning (S240).

The text mining is a mining process for unstructured data. The mining is a process of extracting concepts or characteristics with statistical significance from data and drawing high-quality information such as patterns or trends between the data.

The machine learning refers to a method for allowing a machine to learn by itself through data.

The regulation influence data generation unit 250 may generate regulation influence analysis data based on the extracted information and the template information.

The extracted information may be matched in correspondence with the preset item stored in the template information storage unit 210 (S250).

The regulation influence data generation unit 250 may generate regulation influence analysis data as the extracted information corresponds to the template information (S260).

The generated regulation influence analysis data may be output and displayed on the user terminal 100 (S270).

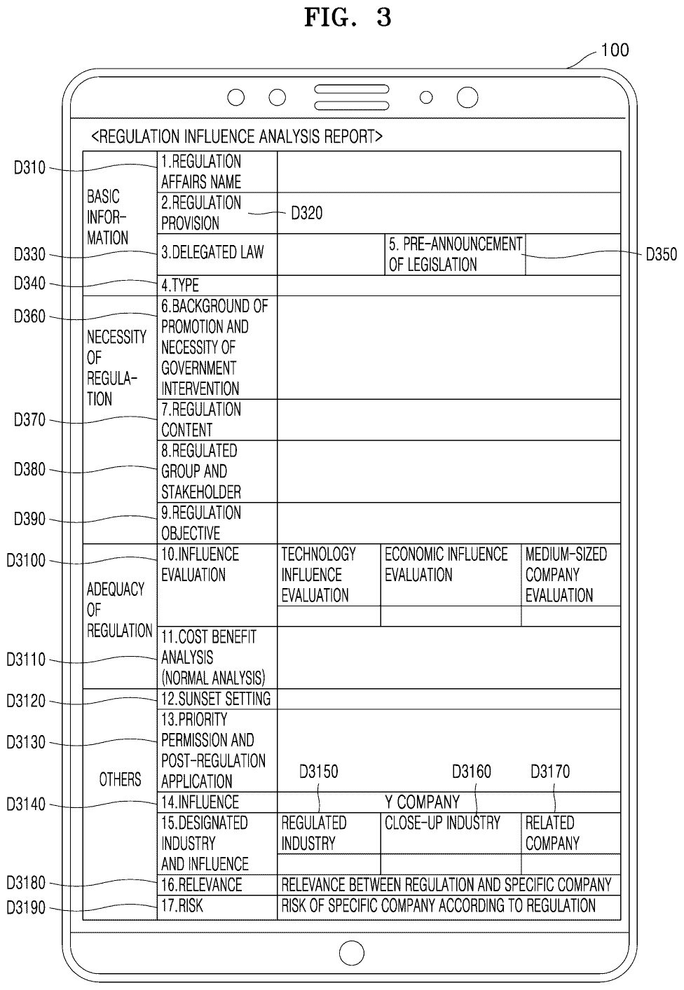

FIG. 3 is a view for showing an interface of the user terminal 100 to which the template information is output according to one embodiment of the present invention.

The preset item in the template information storage unit 210 displayed on the output interface may include a regulation affairs name D310, a regulation provision D320, a delegated law D330, a type D340, pre-announcement of legislation D350, a background of promotion and necessity of government intervention D360, a regulation content D370, a regulated group and stakeholder D380, a regulation objective D390, influence evaluation D3100, a cost benefit analysis D3110, sunset setting D3120, priority permission and post-regulation application D3130, a cost management system, influence D3140, a regulated industry D3150, a close-up industry D3160, a related company D3170, a first relevance, a second relevance D3180, a risk D3190, a relevant overseas case/similar legislative case, and a political party, legislative tendency, and related information of a corresponding member.

Specifically, the regulation affairs name D310 may mean a name of affairs indicating a regulation content.

Specifically, the regulation provision D320 may mean a name and a legal clause for the relevant laws and notices of the bill.

Specifically, the delegated law D330 may mean a name and a legal clause of higher-level law that is the basis of the regulation.

Specifically, the type D340 may indicate whether the regulation is strengthened and/or weakened by the bill, and whether the regulation is newly established and/or abolished by the bill.

Specifically, the pre-announcement of legislation D350 may mean a period for legislative notice of the bill.

Specifically, the background of promotion and necessity of government intervention D360 means the socioeconomic background in which the problem to be solved through the establishment and strengthening of regulations has emerged, and in this case, the background of promotion and necessity of government intervention D360 may indicate the reason why government intervention is necessary.

Specifically, the regulation content D370 may mean content of regulation affairs.

Specifically, the regulated group and stakeholder D380 may mean a regulated person, a stakeholder, an institution, etc., which are direct targets of regulation.

Specifically, the regulation objective D390 may mean an objective to be achieved through the introduction of regulation.

Specifically, the influence evaluation D3100 may mean correspondence of technology, competition, and medium-sized company.

Specifically, the cost benefit analysis D3110 may mean a cost calculation result.

Specifically, the sunset setting D3120 may mean setting of a regulation duration and review period.

Specifically, the priority permission and post-regulation application D3130 may mean application of the comprehensive negative regulation.

Specifically, the influence D3140 may mean an index of the extent to which the proposed bill has an influence on the industry according to the size of the regulated industry, the presence or absence of many related industries and close-up industries, and the presence or absence of many lists of related industries, as a result of analyzing extracted information about the regulated industries, close-up industries, and related industries according to the proposed bill.

Specifically, the regulated industry D3150 may mean an industrial group regulated by the proposed bill.

Specifically, the close-up industry D3160 may mean an industrial group the same as or close to the relevant regulation.

Specifically, the related industry D3170 may mean a list of relevant domestic and overseas companies within the relevant regulation industry.

Specifically, the first relevance may mean conversion of correlation between the regulated group and stakeholder D380, the regulated industry D3150, the close-up industry D3160, and the related company D3170 in the template information into a percentage based on a similarity calculation equation.

Specifically, the second relevance D3180 may mean conversion of correlation between the relevant regulation and a specific company (ID) logged in with a company account into a percentage.

Specifically, the risk D3190 may mean a risk caused by strengthening of regulation on the specific company (ID) logged in with the company account.

Specifically, the cost management system may mean application of the cost management system and cost benefits.

Specifically, the relevant overseas case/similar legislative case may mean a result of searching for an overseas case related to the proposal of the relevant regulation and a legislative case similar to the overseas case.

Specifically, the political party of the corresponding member may mean a political party of a member who proposes the bill when the basic information about the bill is received.

Specifically, the legislative tendency of the corresponding member may mean that legislative tendency of the member who proposes the bill is expressed as regulation strengthening legislative tendency, regulation weakening legislative tendency, etc., when the basic information about the bill is received.

The format of the interface output in FIG. 3 is merely one embodiment of the present invention, and there is no limitation on the changed format and operation of the interface.

At least one component may be added or deleted corresponding to the performance of the components shown in FIG. 3. In addition, it will be easily understood by those skilled in the art that mutual positions of the components may be changed in response to the performance or structure of the system.

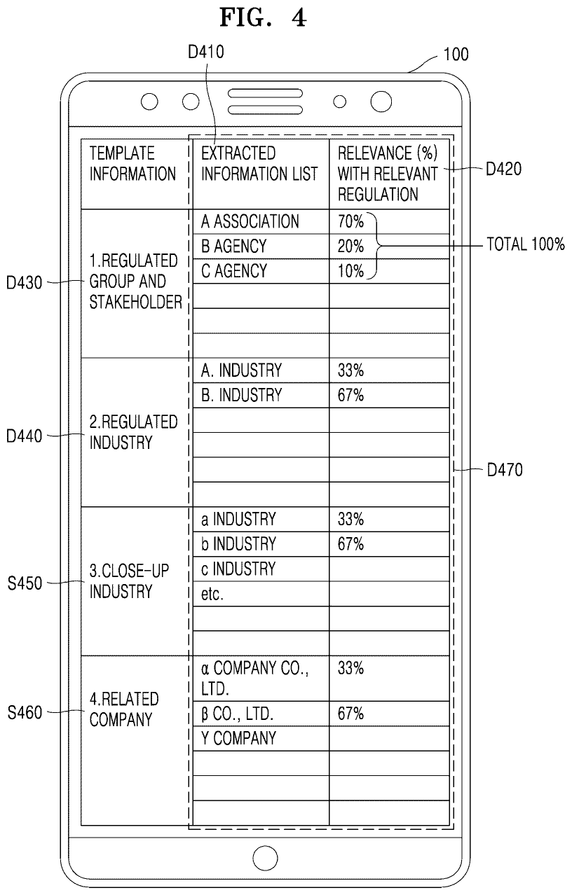

FIG. 4 is a view for showing an interface in which regulation influence analysis data D470, which corresponds to a regulated group and stakeholder D430, a regulated industry D440, a close-up industry D450, and a related company D460, is generated and output to the user terminal 100.

The regulation influence analysis data D470 related to the regulated group and stakeholder D430, the regulated industry D440, the close-up industry D450, and the related company D460 in the template information may include an extracted information list D410.

In addition, the regulation influence analysis data D470 related to the regulated group and stakeholder D430, the regulated industry D440, the close-up industry D450, and the related company D460 in the template information may include conversion D420 of the correlation with the relevant regulation into a percentage based on the similarity calculation equation (hereinafter, referred to as a ‘first relevance’).

The similarity calculation equation may include, for example, at least one of a mean square difference similarity, a cosine similarity, and a Pearson similarity equation.

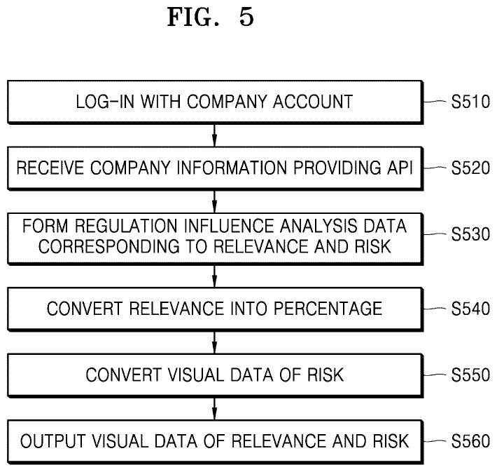

FIG. 5 is a view for showing an operation of outputting visual data about a relevance and a risk by receiving a company information API from a company information providing server when login is made with a company account, according to one embodiment.

The access to the computing system 200 may be performed by logging-in with the company account (S510).

When the login is made with the company account, the account may be identified and managed by an administrator.

In this case, the administrator may grant authority to the data. For example, analysis data about other companies for each company ID is not allowed to be viewed, or data that may not be disclosed according to the subject, such as industry group, legislative entity, regulation party, and regulated person, may be masked.

On the other hand, when the login is made with the company account, domestic and overseas companies may be classified and granted authority according to domestic and overseas characteristics. For example, the characteristics classified according to domestic and overseas may be support business.

When the login is made with the company account as described above, the analysis server 200 may receive the API provided from the company information providing server 300 (S520).

The API provided from the company information providing server 300 may be an API provided from a data analysis retrieval and transfer system (DART).

When the API provided from the data analysis retrieval and transfer system (DART) is received, a process of searching for company disclosure information registered in the system from the DART using the received API and collecting the searched company disclosure information in real time may be performed.

The extracted information formation unit 240 may form extracted information about a second relevance and a risk, and the regulation influence analysis data generation unit 250 may generate regulation influence analysis data corresponding to the second relevance and the risk, respectively (S530).

The second relevance may be calculated based on the similarity calculation equation.

The similarity calculation equation may include, for example, at least one of a mean square difference similarity, a cosine similarity, and a Pearson similarity equation.

The risk may be calculated based on a predetermined algorithm.

A predetermined first algorithm may be an algorithm that outputs the risk as “low” when the second relevance is 0% to 30% in a case where the regulation is weakened and the regulation is strengthened, the risk as “medium” when the second relevance is 30% to 60% in a case where the regulation is strengthened, and the risk as “high” when the second relevance is 60% or greater in a case where the regulation is strengthened.

The regulation influence analysis data about the second relevance may be displayed while being converted into a percentage (S540).

On the other hand, the second relevance may be displayed by other numerical values according to the preset algorithm in addition to the percentage conversion.

For example, by dividing the influence into categories from 1 to 5, the higher the influence, the closer to 5 the numerical value may be displayed, and the lower the influence, the closer to 1 the numerical value may be displayed.

The regulation influence analysis data about the risk may be converted into visual data such as icons and figures in which saturation of colors is displayed differently according to the risk (S550).

For example, when the risk is “high”, the risk may be displayed using Hue: 0 (red), rgb (255, 51, 51), and hex code (#ff3333), when the risk is “medium”, the regulation influence analysis data may be displayed using Hue: 60 (yellow), rgb (255, 255, 51), and hex code (#ffff33), and when the risk is “low”, the regulation influence analysis data may be displayed using Hue: 225 (blue), rgb (51, 51, 255), and hex code (#3333ff).

The converted visual data may be output to the user terminal 100 (S560).

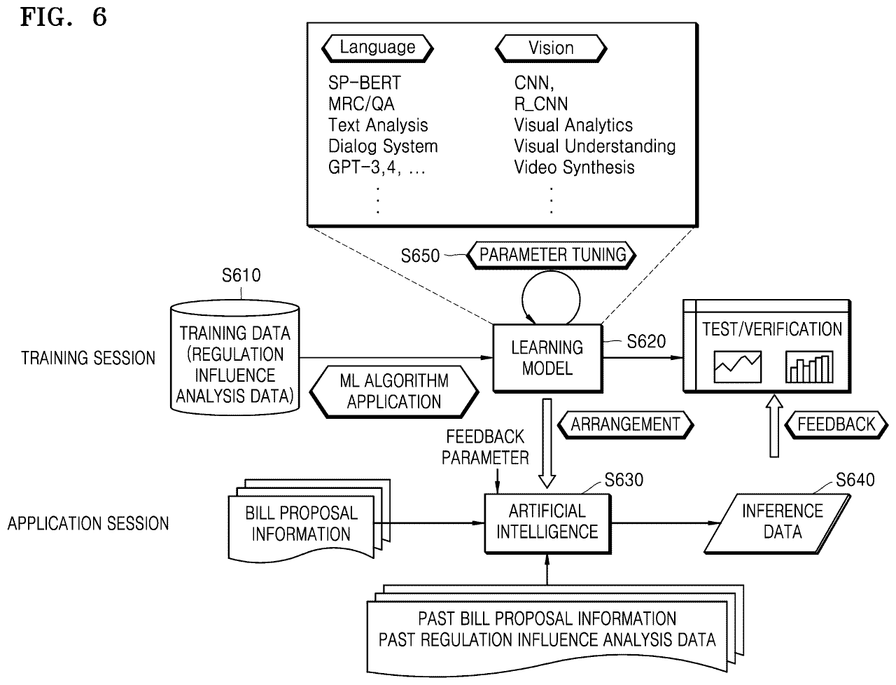

FIG. 6 is a view schematically showing a process of generating regulation influence analysis data through artificial intelligence (AI) learning according to one embodiment.

Training data may be basic information of a first proposed bill, basic information of a first past bill, and data stored in association with first past regulation influence analysis data and first inference data (S610).

A learning model may perform supervised learning using the training data (S620).

The learning model may form learning data through machine learning to provide the learning data to an artificial intelligence module (S630).

Thereafter, when basic information of a second proposed bill, basic information of a second past bill, or second past regulation influence analysis data is input to the artificial intelligence module, second inference data may be output based on the learning data received from the artificial intelligence module (S640).

The output inference data may form feedback information through comparison with a pre-stored ground truth set (S650).

The feedback information may change or tune a parameter of the learning model (S660).

The parameter of the learning model may refer to weight information of each layer included in the learning model.

The supervised learning is to learn mapping between input and output, and is applied when a pair of input and output is given as data. For example, when a license plate is contaminated when a computer recognizes a vehicle license plate at an entrance of a parking lot, the license plate may not be properly recognized. In this case, it is possible to increase a recognition rate of the license plate by training various contaminated license plate cases and normal license plates with the pairs of input and output, respectively.

The learning model may mean an artificial intelligence model trained based on deep learning, and for example, may refer to a model trained using a convolutional neural network (CNN).

In addition, the learning model may include at least one algorithm of Natural Language Processing (NLP), Random Forest (RF), Support Vector Machine (SVC), eXtra Gradient Boost (XGB), Decision Tree (DC), Knearest Neighbors (KNN), Gaussian Naive Bayes (GNB), Stochastic Gradient Descent (SGD), Linear Discriminant Analysis (LDA), Ridge, Lasso, and Elastic net.

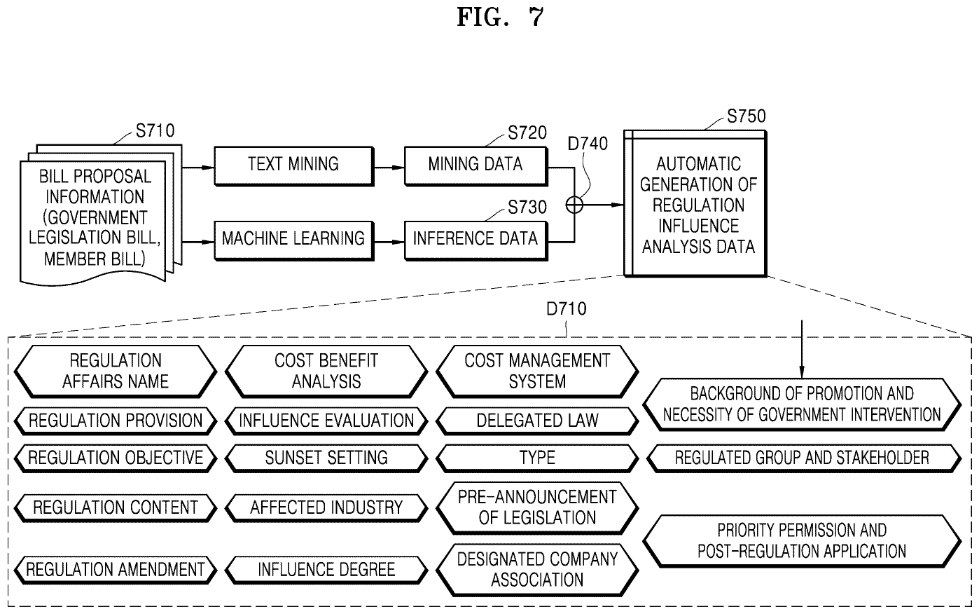

FIG. 7 is a view for explaining an operation of generating the regulation influence analysis data through text mining and machine learning according to one embodiment.

The basic information reception unit 220 may receive the basic information of the proposed bill (S710).

When the basic information is received by the basic information reception unit 220, the extracted information generation unit 240 may generate mining data by extracting text, which is unstructured data, through text mining (S720).

Meanwhile, when the basic information is received by the basic information reception unit 220, the extracted information formation unit 240 may provide learning data to the artificial intelligence module through machine learning, and may form inference data when the basic information of the bill is input based on the provided learning data (S730).

The extracted information formation unit 240 may collect the mining data and the inference data formed as described above (S740).

When the mining data and the inference data are collected, the mining data and the inference data may be transmitted to the regulation influence data generation unit, and the regulation influence data generation unit 250 may generate regulation influence analysis data based on preset template information D710 (S750).

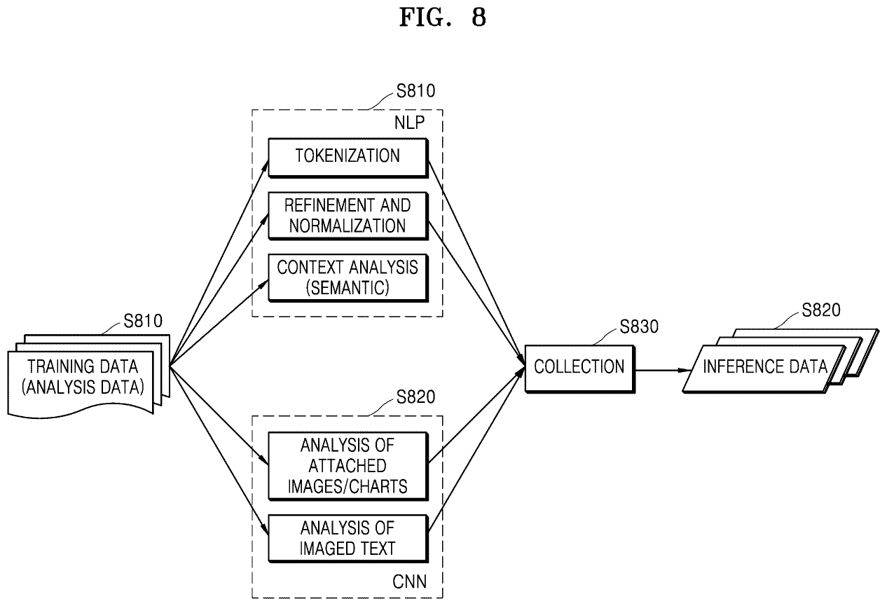

FIG. 8 is a view for explaining an operation of generating inference data through machine learning according to one embodiment.

Referring to FIG. 8, the training data may be trained by the learning model to form inference data.

The training data D810 learning model may use natural language processing (NLP) for language processing (tokenization, refinement and normalization, and context analysis) (S810), and may use a convolutional neural network (CNN) for image/image processing (attached image/chart analysis, imaged text analysis) (S820).

Specifically, the tokenization is a text preprocessing process, and may be classified into sentence tokenization and word tokenization, in which the sentence tokenization means an operation of separating sentences from text, and the word tokenization means an operation of separating words from text into tokens.

Meanwhile, the token may be defined as a meaningful unit.

Specifically, refinement means removal of noise data from a corpus. Meanwhile, the corpus means a collection of words and texts.

Specifically, the normalization means unifying words having different expression methods into the same word.

Specifically, the context analysis means an analysis task that allows a machine to understand by identifying the context in a natural language processing process, expressing words as numerical values, and separating the same into vectors.

Specifically, the image/chart analysis is an analysis that learns directly from data and classifies images/charts using patterns, which may be particularly useful for finding patterns to recognize images/charts.

Specifically, the imaged text analysis is a technique for recognizing the imaged text by a deep learning-based model, and may be performed by a pre-processing step of changing metadata of an image such as brightness or color such that characters may be clearly seen, a character detection step of finding a position where the characters exist and binding the characters to a bounding box, and a character recognition step of finding out what content the characters are in the bounding box.

An operation of collecting data that has passed through the natural language processing and image/image processing learning model may be performed (S830).

The collected data may be formed into inference data D820.

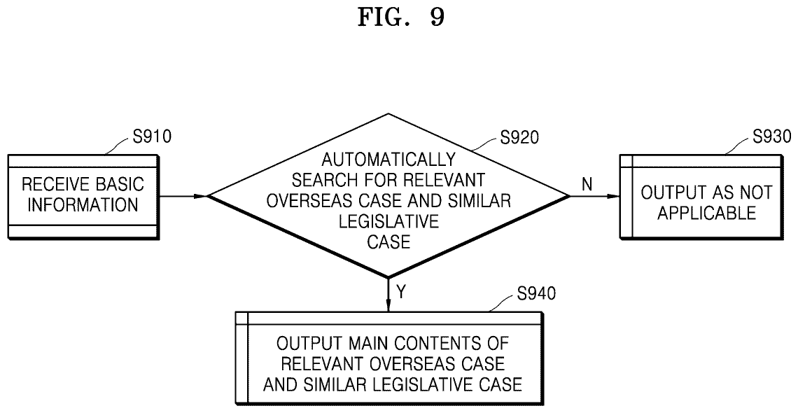

FIG. 9 is a view for explaining an output value according to the presence or absence of a relevant overseas case and a similar legislative case according to one embodiment.

The basic information reception unit may receive the basic information of the bill (S910).

In the step of automatically searching for relevant overseas cases and similar legislative cases, an operation of automatically searching for overseas cases and similar legislative cases related to the basic information of the bill, which is received by the basic information reception unit 220, using a predetermined second algorithm may be performed (S920).

The predetermined second algorithm of the step of automatically searching for the relevant overseas cases and similar legislative cases may include a similarity calculation equation, such as at least one of a mean square difference similarity, a cosine similarity, and a Pearson similarity equation.

In addition, the predetermined second algorithm of the step of automatically searching for relevant overseas cases and similar legislative cases may include an operation of automatically searching for keywords in an Internet server to find an output value.

Meanwhile, a method of automatically searching for and extracting keywords may be performed by text mining or natural language processing (NLP) by machine learning on the basic information of the bill.

On the other hand, main contents of relevant overseas cases may include Internet newspaper articles, broadcasting contents, and overseas legislative cases.

On the other hand, the main contents of similar legislative cases may include legal clauses, titles of legal clauses, and contents of legal clauses.

On the other hand, the similar legislative cases may include both domestic and overseas similar legislative cases.

The legal clauses may include not only provisions of law, but also subordinate laws such as enforcement ordinances and enforcement regulations.

When the relevant overseas cases and similar legislative cases are automatically searched, a case where there are no relevant overseas cases and similar legislative cases may be displayed as not applicable on the user terminal 100 (S930).

Meanwhile, when there are relevant overseas cases and similar legislative cases, the relevant overseas cases and similar legislative cases may be displayed on the user terminal by calculating the main contents of the relevant overseas cases and similar legislative cases and recommending the main contents (S940).

The calculation of the main contents may be performed based on a text abstraction model.

The text abstraction model may refer to an extraction model that generates a sentence by combining words drawn from a document or an abstraction model that generates a sentence using words or expressions not used in a document without changing the meaning.

The server in the computing system 200 may receive an API including information about the calculated main contents.

The received API of the main contents may be displayed on the user terminal 100 while being transmitted and output to the user terminal 100.

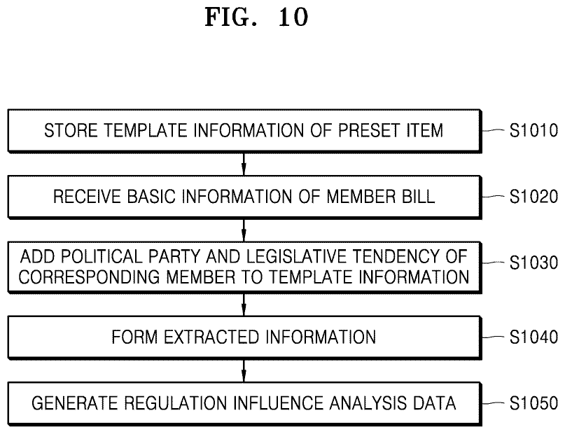

FIG. 10 is a view for explaining an operation of adding the template information when basic information about a member bill is received, according to one embodiment.

The template information storage unit 210 in the computing system 200 may store a template item preset by the administrator (S1010).

The basic information reception unit 220 may receive the basic information of the bill.

The basic information of the bill received by the basic information reception unit 220 may be basic information about a government legislation bill or basic information about the member bill.

The basic information reception unit 220 may divide the basic information into the basic information about the government legislation bill and the basic information about the member bill, and may receive the basic information about the member bill (S1020).

When the basic information reception unit 220 receives the basic information about the member bill, the template storage unit 210 may additionally store an item of the political party and legislative tendency of the member who proposes the bill (S1030).

The extracted information formation unit 240 may additionally perform a process of classifying a political party, legislative tendency, and a purpose of proposing a bill of the corresponding member through text mining or machine learning based on information about the member who proposes the bill.

The extracted information formation unit 240 may form extraction information about the added political party and legislative tendency of the member (S1040).

The regulation influence analysis data generation unit 250 may generate regulation influence analysis data by matching the template information to the extracted information about the political party and legislative tendency of the member (S1050).

Meanwhile, the operations performed by these methods may be executed by a computer program stored in a medium.

According to the present invention, it is possible to provide a method or an apparatus for monitoring a new bill or legal regulation, which can automatically generate a regulation influence analysis report and provide a user with influence of the relevant regulation even when a government legislation bill is weakened and a member bill is proposed as well as when the government legislation bill is newly established or strengthened to monitor the bill or legal regulation.

The effects of the present invention are not limited to the effects described above, and other effects that are not described will be clearly understood by those skilled in the art from the following description.

The methods related to the embodiments of the present invention or the algorithm steps may be implemented directly in hardware, implemented in a software module executed by hardware, or implemented by a combination thereof. The software module may be stored in a random access memory (RAM), a read only memory (ROM), an erasable programmable ROM (EPROM), an electrically erasable programmable ROM (EEPROM), a flash memory, a hard disk, a removable disk, a CD-ROM, or any form of computer-readable recording medium that is well known in the art to which the present invention pertains.

Although the embodiments of the present invention have been described above with reference to the accompanying drawings, those skilled in the art to which the present invention pertains will understand that the present invention may be implemented in other specific forms without changing the technical spirit or essential features thereof. Accordingly, the detailed description should not be construed as being limitative from all aspects, but should be construed as being illustrative.

1. A method for monitoring a bill and a legal regulation, which is performed by a computing system including at least one memory and at least one processor, the method comprising:
storing template information including a preset item;
receiving, from a user terminal, basic information including main contents and proposal reasons of the bill;
storing the basic information in an analysis server;
forming extracted information from the basic information through text mining, based on the preset item;
generating regulation influence analysis data based on the extracted information and the template information; and
outputting a regulation influence analysis interface for the bill or legal regulation to the user terminal, based on the generated regulation influence analysis data.

2. The method of claim 1, wherein the forming of the regulation influence analysis data includes generating regulation influence analysis data by matching the extracted information to each preset item in the template information.

3. The method of claim 1, wherein the preset item includes a regulation affairs name, a regulation provision, a delegated law, a type, pre-announcement of legislation, a background of promotion, necessity of government intervention, a regulation objective, a regulation content, a regulated group, a stakeholder, cost benefit analysis, influence evaluation, sunset setting, priority permission, post-regulation application, a cost management system, a regulated industry, a close-up industry, and a related company.

4. The method of claim 3, wherein the generating of the regulation influence analysis data further includes:
calculating a first relevance between the proposed bill and the extracted information corresponding to each of the regulated group and the stakeholder, the regulated industry, the close-up industry, and the related company, based on a predetermined similarity calculation equation; and
generating regulation influence analysis data about the first relevance.

5. The method of claim 3, further comprising receiving, when logging-in to the computing system using an account of a specific company, information about the specific company provided from a company information providing server through an application programming interface (API) provided from the company information providing server,
wherein the generating of the regulation influence analysis data further includes:
calculating a second relevance between the specific company and the bill based on a predetermined similarity calculation equation;
generating regulation influence analysis data about the second relevance;
converting the regulation influence analysis data about the second relevance into a percentage; and
outputting the percentage to the user terminal based on the information about the specific company, and
the second relevance is included in the preset item.

6. The method of claim 3, further comprising receiving, when logging-in to the computing system using an account of a specific company, information about the specific company provided from a company information providing server through an application programming interface (API) provided from the company information providing server,
wherein the generating of the regulation influence analysis data further includes:
calculating a risk of the specific company by the bill based on a predetermined first algorithm;
generating regulation influence analysis data about the risk;
converting the regulation influence analysis data about the risk into visual data based on the risk corresponding to the regulation influence analysis data; and
outputting the visual data to the user terminal based on the information about the specific company,
the risk is included in the preset item, and
the visual data includes saturation information corresponding to the risk.

7. The method of claim 5, further comprising:
performing supervised learning through a learning model based on training data that is stored in association with basic information of a first proposed bill, basic information of a first past bill, first past regulation influence analysis data, and first inference data;
forming learning data through machine learning of the learning model;
providing an artificial intelligence module with the learning data;
outputting second inference data based on the learning data received from the learning model, when basic information of a second proposed bill, basic information of a second past bill, and second past regulation influence analysis data are input;
forming feedback information based on a difference between the second inference data and a pre-stored ground truth set; and
changing a parameter of the learning model based on the feedback information.

8. The method of claim 7, wherein the generating of the regulation influence analysis data further includes generating the regulation influence analysis data based on mining data, which is obtained by performing text mining on the basic information, and the second inference data.

9. The method of claim 7, further comprising:
determining a relevant overseas case and a similar legislative case corresponding to the basic information using a predetermined second algorithm;
extracting main contents of the relevant overseas case and the similar legislative case;
transmitting the main contents to the user terminal; and
outputting the main contents to the user terminal.

10. The method of claim 7, wherein when the basic information of the second proposed bill includes basic information about a member bill, it is determined that the preset item further includes a political party and legislative tendency of a member who proposes a second bill.

11. A computer program stored in a medium for executing the method of claim 1.

12. The method of claim 6, further comprising:
performing supervised learning through a learning model based on training data that is stored in association with basic information of a first proposed bill, basic information of a first past bill, first past regulation influence analysis data, and first inference data;
forming learning data through machine learning of the learning model;
providing an artificial intelligence module with the learning data;
outputting second inference data based on the learning data received from the learning model, when basic information of a second proposed bill, basic information of a second past bill, and second past regulation influence analysis data are input;
forming feedback information based on a difference between the second inference data and a pre-stored ground truth set; and
changing a parameter of the learning model based on the feedback information.

13. The method of claim 12, wherein the generating of the regulation influence analysis data further includes generating the regulation influence analysis data based on mining data, which is obtained by performing text mining on the basic information, and the second inference data.

14. The method of claim 12, further comprising:
determining a relevant overseas case and a similar legislative case corresponding to the basic information using a predetermined second algorithm;
extracting main contents of the relevant overseas case and the similar legislative case;
transmitting the main contents to the user terminal; and
outputting the main contents to the user terminal.

15. The method of claim 12, wherein when the basic information of the second proposed bill includes basic information about a member bill, it is determined that the preset item further includes a political party and legislative tendency of a member who proposes a second bill.
